(19) United States
(12) Patent Application Publication
(10) Pub. No.: US 2024/0077039 A1
(43) Pub. Date: Mar. 7, 2024

(54) OPTIMIZATION CONTROL METHOD FOR AERO-ENGINE TRANSIENT STATE BASED ON REINFORCEMENT LEARNING

(71) Applicant: DALIAN UNIVERSITY OF TECHNOLOGY, Dalian, Liaoning (CN)

(72) Inventors: Ximing SUN, Dalian, Liaoning (CN); Junhong CHEN, Dalian, Liaoning (CN); Fuxiang QUAN, Dalian, Liaoning (CN); Chongyi SUN, Dalian, Liaoning (CN)

(21) Appl. No.: 18/025,531

(22) PCT Filed: May 11, 2022
(86) PCT No.: PCT/CN2022/092092

§ 371 Date: Sep. 14, 2023

(30) Foreign Application Priority Data
Mar. 7, 2022 (CN) 202210221726.2

(51) Int. Cl. F02C 9/44; G05B 13/02; G05B 13/04

(52) U.S. Cl. CPC F02C 9/44; G05B 13/027; G05B 13/042

(57) ABSTRACT

The present invention provides an optimization control method for an aero-engine transient state based on reinforcement learning, and belongs to the technical field of aero-engine transient states. The method comprises: adjusting an existing twin-spool turbo-fan engine model as a model for invoking a reinforcement learning algorithm; to simultaneously satisfy high level state space and continuous action output of a real-time model, designing an Actor-Critic network model; designing a deep deterministic policy gradient (DDPG) algorithm based on an Actor-Critic frame, to simultaneously solve the problems of high-dimensional state space and continuous action output; training the model after combining the Actor-Critic frame with the DDPG algorithm; and obtaining the control law of engine acceleration transition from the above training process, and using the method to control an engine acceleration process.

### TECHNICAL FIELD

The present invention belongs to the technical field of aero-engine transient states, and relates to an optimization control method for acceleration of an aero-engine transient state.

### BACKGROUND

The operation performance of an aero-engine in various transient states is a very important index to measure the performance of the aero-engine. Acceleration process control is typical transient state control of the aero-engine. The rapidity and safety of acceleration control directly affect the performance of the aero-engine and aircraft. In general, acceleration control requires the minimum time for the engine to make transition from an operating state to another operating state under the given constraints of various indexes.

The existing methods can be mainly divided into the following three types: the approximate determination method, the optimal control method based on dynamic programming and the power extraction method. The approximate determination method determines the acceleration law of the engine transient state based on the operation condition of the approximate transient state of the equilibrium equation under the stable operating state of the engine, and has the disadvantages of low design accuracy and complicated implementation process. The dynamic programming method is an optimization method with various constraints based on the calculation model of engine dynamic characteristics, which establishes an objective function of required performance directly on the basis of the model, and seeks an optimal transient state control law through an optimization algorithm. The key is the realization of nonlinear optimization algorithms which commonly include the constrained variable metric method, the quadratic sequence programming method and the genetic algorithm. This method has the disadvantages of complicated numerical method, large amount of calculation and robustness problem. The power extraction method addes the extraction power of rotors based on the calculation model of engine steady characteristics, to make it approximate to the transient state condition, so as to design an optimal control law. This method ignores the influences of factors such as volume effect and dynamic coupling among multiple rotors. In the existing transient state control methods of the aero-engine, the design of the acceleration control law has the problems of complicated design process, poor robustness and small operating range.

### SUMMARY

In view of the problems of complicated design, small operating range and poor robustness in the existing design method for the transient state control law of the aero-engine, the present invention provides an acceleration control method for an aero-engine transient state based on reinforcement learning.

The present invention adopts the following technical solution:

A design process of an acceleration control method for an aero-engine transient state based on reinforcement learning comprises the following steps:

S1 Adjusting an existing twin-spool turbo-fan engine model as a model for invoking a reinforcement learning algorithm. Specifically:

S1.1 Selecting input and output variables of the twin-spool turbo-fan engine model according to the control requirements for the engine transient state, comprising fuel flow, flight conditions, high and low pressure rotor speed, fuel-air ratio, surge margin and total turbine inlet temperature.

S1.2 To facilitate the invoking and training of the reinforcement learning algorithm, packaging the adjusted twin-spool turbo-fan engine model as a directly invoked real-time model to accelerate the training and simulation speed so that the training speed is greatly increased compared with the traditional model which directly conducts training.

S2 To simultaneously satisfy high level state space and continuous action output of the real-time model, designing an Actor-Critic network model. Specifically:

S2.1 Generating actions by an Actor network which is composed of the traditional deep neural network, wherein the output behavior aₜ of each step can be determined by a deterministic policy function μ(sₜ) and an input state s; fitting the policy function by the deep neural network, with a parameter of θ^{μ}, and determining the specific content of each parameter according to actual needs.

S2.2 Designing a corresponding Actor network structure, comprising an input layer, a hidden layer and an output layer, wherein the functions of the hidden layer need to comprise mapping a state to a feature, normalizing the output of a previous layer and simultaneously inputting an action value. An activation function can be selected from ReLU function or Tanh function, but it is not limited to this. Common activation functions are:

$$( 1 ) Sigmoid function$$

$$f ( z ) = \frac{1}{1 + {e}^{- z}}$$

$$( 2 ) Tanh function$$

$$tanh ( x ) = \frac{{e}^{x} - {e}^{- x}}{{e}^{x} + {e}^{- x}}$$

$$( 3 ) ReLU function$$

$$Relu = max ( 0 , x )$$

$$( 4 ) PReLU function$$

$$f ( x ) = max ( α x , x )$$

$$( 5 ) ELU function$$

$$f ( x ) = \{ \begin{matrix}x , & if x > 0 \\ α ( {e}^{x} - 1 ) , & otherwise\end{matrix}$$

S2.3 The Critic network is used for evaluating the performing quality of the action, and is composed of the deep neural network; an input thereof is a state-action group (s, a), an output is a Q value function of a state-action value function and a parameter is θ^{Q}; and the specific content of each parameter is determined according to actual needs.

S2.4 Designing a corresponding Critic network structure, and adding the hidden layer after the input state s in order to satisfy that the network can better mine relevant features. Meanwhile, because the input of the Critic network should have an action a, feature extraction is carried out after weighted summation with the features of the state s. The final output result should be a Q value related to the performing quality of the action.

S2.5 It should be pointed out that the main function of the deep neural network is to serve as a function fitter, so too many hidden layers are not conducive to network training and convergence and meanwhile, a simple fully connected network should be selected to accelerate the convergence speed.

S3 Designing a deep deterministic policy gradient (DDPG) algorithm based on an Actor-Critic frame, estimating the Q value by the Critic network and outputting an action by the Actor network, so as to simultaneously solve the problems of high-dimensional state space and continuous action output which cannot be solved by the traditional DQN algorithm. Specifically:

S3.1 Reducing the correlation between samples by an experience replay method and a batch normalization method. A target network adopts a soft update mode to make the weight parameters of the network approach an original training network slowly to ensure the stability of network training. Deterministic behavior policies make the output of each step computable.

S3.2 The core problem of the DDPG algorithm is to process a training objective, that is, to maximize a future expected reward function J(μ), while minimizing a loss function L(θ^{Q}) of the Critic network. Therefore, an appropriate reward function should be set to make the network select an optimal policy. The optimal policy μ defined as a policy that maximizes J(μ), which is defined as μ=argmax_{μ}J(μ). In this example, according to the target requirements of the transient state, the objective function is defined as minimizing surge margin, total temperature before turbine and acceleration time.

S3.3 The DDPG algorithm is an off-policy algorithm, and the process of learning and exploration in continuous space can be independent of the learning algorithm. Therefore, it is necessary to add noise to the output of the Actor network policy to serve as a new exploration policy.

S3.4 To avoid that the neural network is difficult to find hyperparameters that can be targeted at different environments and ranges and have good generalization ability due to the difficulty of effective learning caused by large differences between different physical units and values of different components during learning from low-dimensional feature vector observation, standardizing each dimension of a training sample in a design process to have unit mean value and variance.

S4 Training the model after combining the Actor-Critic frame with the DDPG algorithm. Specifically:

S4.1 Firstly, building corresponding modules for calculating reward and penalty functions according to the existing requirements.

S4.2 Combining the engine model with a reinforcement learning network to conduct batch training. Compared with the traditional direct training mode, this training method can train the complicated engine model to a better target result. Because the engine model is complicated and the transient state is a dynamic process, during training, the range of a target reward value is manually increased for pre-training. After basic requirements are satisfied, the range of the target reward value is reduced successively until the corresponding requirements are satisfied.

S4.3 To make the policy optimal and a controller robust, adding±5% random quantity to a reference target to make a current controller model have optimal control quantity output.

S4.4 To design a fuel supply law which satisfies multiple operating conditions, changing the target speed of the rotor on the premise of keeping height and Mach number unchanged, and conducting the training for several times.

S5 Obtaining the control law of engine acceleration transition from the above training process, and using the method to control an engine acceleration process, which mainly comprises the following steps:

S5.1 After the training, obtaining corresponding controller parameters. It should be noted that each operating condition corresponds to a controller parameter. At this time, the controller input is a target speed value and the output is the fuel flow supplied to the engine.

S5.2 Directly giving the control law by the model under the current operating condition, and controlling the transient state of the engine acceleration process only by directly communicating the output of the model with the input of the engine.

The present invention has the beneficial effects: compared with the traditional nonlinear programming method, the optimization method for engine acceleration transition provided by the present invention uses a reinforcement learning technology, a neural network approximation technology and a dynamic programming method to avoid the trouble of curse of dimensionality and back to front solving time caused by solving HJB equation, and can directly and effectively solve the problem of designing an optimal fuel accelerator program. At the same time, the controller designed by the method can be applied to the acceleration transition under various operating conditions, so that the adaptability of the engine acceleration controller is improved and is closer to the real operating condition of the aircraft engine under various conditions. In addition, in the process of designing the controller, a certain degree of disturbance is added to both input and output, so that the controller performance after learning is more reliable and robust enough. Finally, in the process of designing reward and penalty functions, the objective function and various boundary conditions of the optimal engine control are directly taken as the reward and penalty functions. The design mode is simple, the final result is fast in response, the overshooting is small, and the control accuracy meets the requirements. Compared with other existing intelligent control methods, this design method is more concise and convenient to implement.

### DESCRIPTION OF DRAWINGS

FIG. 1 is a flow chart of design of a control system for an aero-engine transient state based on reinforcement learning;

FIG. 2 is a structural schematic diagram of a control system for an aero-engine transient state based on reinforcement learning;

FIG. 3 is a structural schematic diagram of a system of an engine model;

FIG. 4 shows an Actor network structure;

FIG. 5 shows a Critic network structure;

FIG. 6 is an Actor-Critic network frame;

FIG. 7 shows a training flow of DDPG algorithm based on an Actor-Critic network frame;

FIG. 8 shows a control process of 80% speed acceleration, wherein Fig. (a) is a change curve of low pressure rotor speed, Fig. (b) is a change curve of high pressure rotor speed, Fig. (c) is a change curve of total temperature before turbine, Fig. (d) is a change curve of compressor surge margin, and Fig. (e) shows a fuel flow required for acceleration, which is also control quantity; and

FIG. 9 shows a control process of 100% speed acceleration, wherein the meanings of Fig. (a), Fig. (b), Fig. (c), Fig. (d) and Fig. (e) are the same as those described in the above figures.

### DETAILED DESCRIPTION

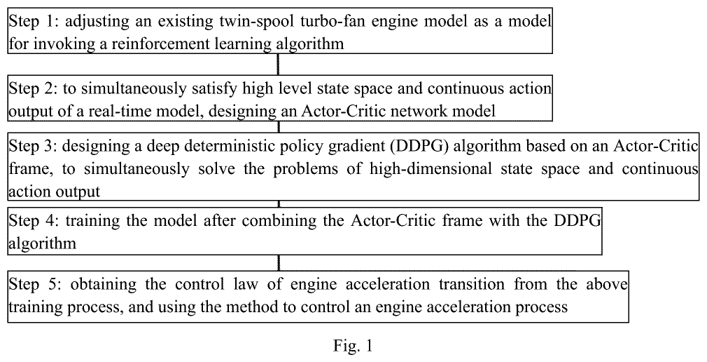

The present invention is further illustrated below in combination with the drawings. A twin-spool turbo-fan engine is taken as a controlled object in the implementation of the present invention listed here. A flow chart of design of a control system for an aero-engine transient state based on reinforcement learning is shown in FIG. 1.

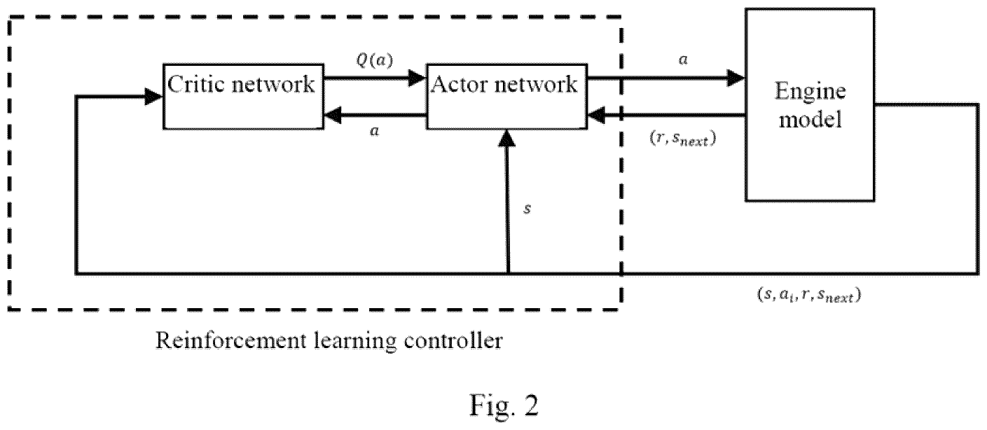

FIG. 2 is a structural schematic diagram of a control system for an aero-engine transient state based on reinforcement learning. It can be seen from the figure that the controller mainly comprises two parts: an action network and an evaluation network, wherein the action network outputs the control quantity, and the evaluation network outputs an evaluation index. The controlled object is the turbo-fan engine which outputs information such as engine state. In the design process of the controller, actually, an appropriate evaluation index function is set, the action network and the evaluation network are trained to obtain an optimal weight value, and finally a complete control law of the engine transient state is obtained. For convenience, the main parameters and meanings involved in the design process of the controller are shown in Table 1.

TABLE 1
Main Design Parameters and Meanings of Control System for
Aero-Engine Transient State Based on Reinforcement Learning

| Symbol | Meaning |
|---|---|
| H | Height |
| Ma | Mach number |
| T₄ | Total temperature before turbine |
| W_{f} | Fuel flow |
| n_{L} | Low pressure rotor speed |
| n_{H} | High pressure rotor speed |
| SM_{c} | Compressor surge margin |
| Far | Fuel-air ratio |
| ΔW_{f} | Change rate of fuel flow |
| a | Action |
| s | State |
| π | Policy |
| Q | Gain obtained by the current action in a |
| | deterministic state |

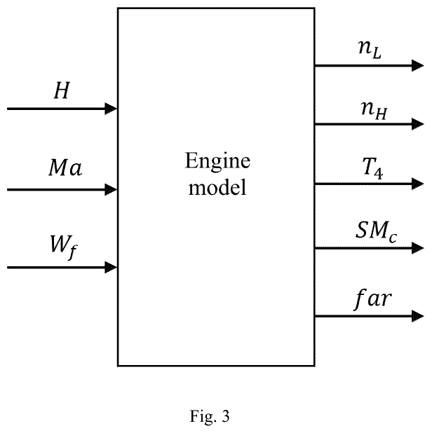

FIG. 3 is a structural schematic diagram of a system of an engine model. Through the analysis of transient state control requirements, the input and the output of the engine model are adjusted. In this example, the inputs required by the engine model are height, Mach number and fuel flow, and the output states are low pressure rotor speed, high pressure rotor speed, total temperature before turbine, fuel-air ratio and compressor surge margin.

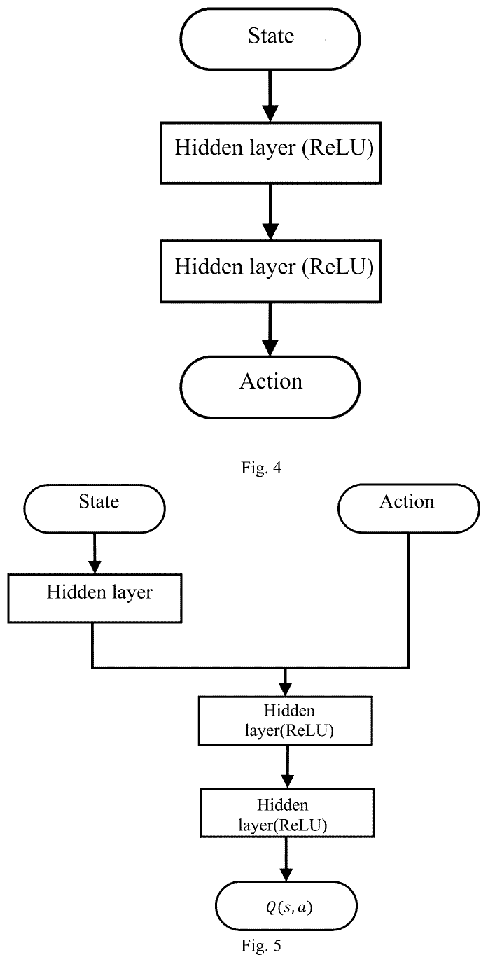

FIG. 4 shows an Actor network structure. The input and the output of the Actor network are the state quantity s and the action quantity a of a model environment respectively. In this example, the state quantity of the environment is the low pressure rotor speed of the engine, and the action quantity is the fuel flow of the engine. The output of the action quantity at each step can be obtained by a deterministic policy function u, and a calculation formula is aₜ=μ(sₜ). The acquisition of the policy function can be fitted by the deep neural network. In this example, because the engine model is a strong nonlinear model, too many hidden layers are not conducive to model training and feature extraction. Thus, the Actor network has four layers. A first layer is an input layer; a second layer is a hidden layer, which aims to map an engine state to a feature; a third layer is a hidden layer, which aims to normalize the feature to obtain an action value, i.e., fuel flow; the two hidden layers select relatively simple ReLU functions as activation functions; and a last layer is an output layer. A chain rule is adopted to update the network. Firstly, the policy function is parameterized to obtain a policy network μ(s|θ); an expected future function J is used to take the derivative of the parameter to obtain a policy gradient; and then all the action values transmitted to the model are obtained, so as to obtain a state transition set which is used to train the policy to obtain an optimal policy. A calculation formula of the policy gradient is:

∇_{θ}J=Eₛ_{_{t˜ρ}}_{^{β}}[∇_{α}Q(sₜ,α|ω)|_{α=μ(s}_{ₜ})∇_{θ}μ(sₜ|θ)]

In the formula, θ is a network parameter; sₜ is a current state; ρ^{β} is the policy state access distribution of all the actions, a is the action quantity, Q is the Critic network, μis the Actor network, ω is a network parameter, and E is an expected function. The network is trained through the formula, and the optimal policy is obtained.

FIG. 5 shows a Critic network structure. The inputs of the Critic network are a state and an action, and the output is a Q value function. A 5-layer network is set, which comprises an input layer, three hidden layers and an output layer respectively. Different from the Actor network, the Critic network has two inputs. One input is a state, which requires a hidden layer to extract features, and the other input is an action. The weighted sum of the action value and the above feature is taken as the input of the next hidden layer, and then Q value is outputted to the output layer through the other hidden layer. The Critic network uses the same activation function as the Actor network and also uses ReLU function as the activation function. The Q value function represents an expected return value obtained by executing the action according to the selected policy in the current state, and a calculation formula is:

Q^{π}(s,α)=Eₛ_{_{next˜p}}(sₙₑₓₜ|s,α)[r(s,α,sₙₑₓₜ)+γE_{αnext˜π(α}_{ₙₑₓₜ}^{|s}ₙₑₓₜ₎[i Q^{π}(sₙₑₓₜ,αₙₑₓₜ)]]

In the formula, Q is the Critic network, s is the state quantity, a subscript next represents a next moment, a is the action quantity, π is a policy, E is an expected function, r is a reward function, γ is a discount factor, and next is a value at the next moment. In order to find a way to update the parameters of the Critic network, a loss function is introduced and minimized to update the parameters. The loss function is expressed as:

Loss(θ^{Q})=E_{s˜ρ}_{^{β}}_{,α˜β,r˜E}[(Q(s,α|Q^{θ})−γ)²]

γ=r(s,α,sₙₑₓₜ)+γQₙₑₓₜ(sₙₑₓₜ,μₙₑₓₜ(sₙₑₓₜ|θ⁸² ^{ₙₑₓₜ})|θ^{Q}^{ₙₑₓₜ})

In the formula, Loss is a damage function; θ is a network parameter; Q is the Critic network; ρ^{β} is the policy state access distribution of all the actions; α is an update step length; β is access distribution of step length; s is a state; r is a reward function; E is an expected function; y is a calculation target label; a is the action quantity; a subscript next represents a next moment; γ is a discount factor; and μ is the Actor network.

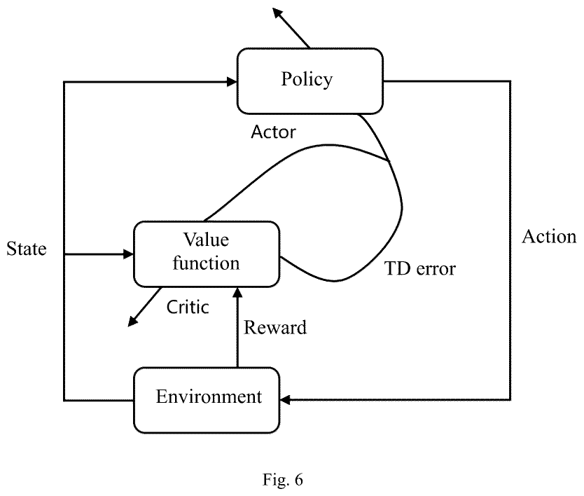

FIG. 6 is an Actor-Critic network frame. It can be seen from the figure that the network frame has two structures: a policy and a value function. The policy is used for selecting the action, and the value function is used for assessing the quality of the action generated by the policy. An evaluation signal is expressed in the form of a time difference (TD) error, and then the policy and the value function are updated.

A specific form can be expressed as: after the policy obtains a state from the environment and selects an action, the value function evaluates a new state generated at this moment and determines its error. If the TD error is positive, it proves that the action selected at this moment makes the new state closer to an expected standard, and preferably performs this action again next time when the same state is encountered. Similarly, if the TD error is negative, it proves that the action at this moment may not make the new state closer to the expected standard, and this action may not be performed in this state in the future. Meanwhile, a policy gradient method is selected for updating and optimizing the policy. This method may constantly calculate the gradient value of the expected total return obtained from the execution of the policy for the policy parameters, and then update the policy until the policy is optimal.

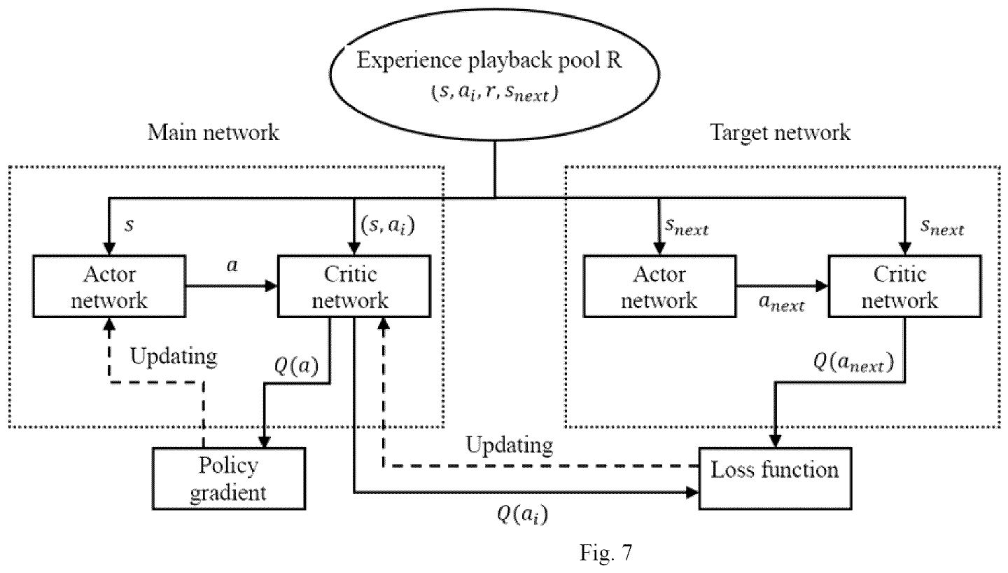

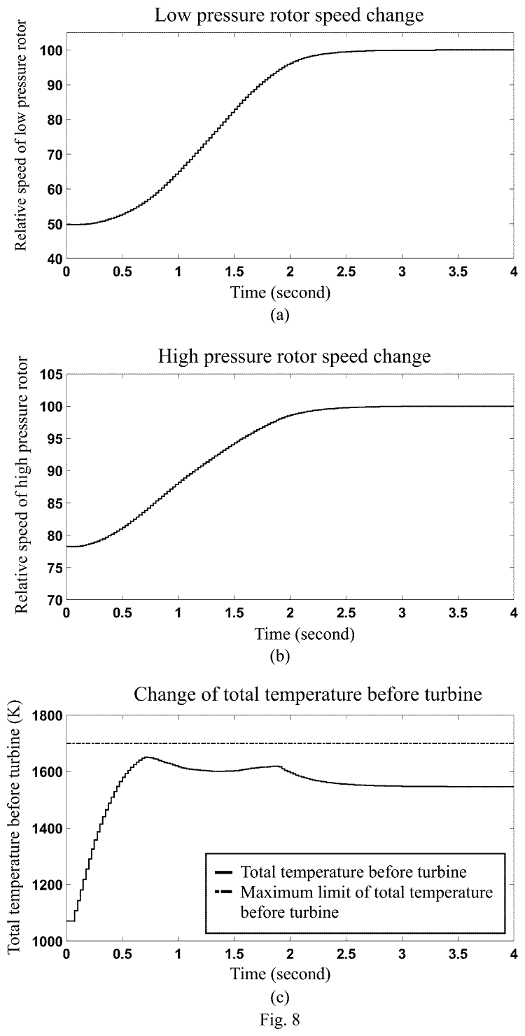

FIG. 7 shows a training flow of DDPG algorithm based on an Actor-Critic network frame. Firstly, the weights of the Actor network μ(s|θ^{μ}) and the Critic network Q(s,a |θ^{Q}) are randomly initialized. Then, the target Actor network and the target Critic network are initialized to make the weight the same as that of the previous step, and meanwhile, an experience playback pool is initialized. For each round, the engine state is randomly initialized. For each step length in this round, an action is calculated and output according to the current policy at first. Then, the engine performs the action and obtains the state at a next moment and a return value. The current experience including the current state, the current action, the state at a next moment and the return value is stored in the experience playback pool, and then M experience is randomly sampled in a small batch from the experience playback pool. A current target label value y is calculated, the current loss function Loss(θ^{Q}) is calculated through y, and the loss function is minimized to update the weight of the Critic network. Then, the weight of the Actor network is updated by the policy gradient method, and the target network is updated by soft updating criteria. This updating method improves the learning stability and makes the robustness better. The formula is:

$$\{ \begin{matrix}{θ}^{{Q}_{next}} ← ξ {θ}^{Q} + ( 1 - ξ ) {θ}^{{Q}_{next}} \\ {θ}^{{μ}_{next}} ← ξ {θ}^{μ} + ( 1 - ξ ) {θ}^{{μ}_{next}}\end{matrix}$$

In the formula, θ is a network parameter; Q is the Critic network; μ is the Actor network; ζ is a soft update rate; and a subscript next represents a next moment. At this point, the current round is ended and repeated for many times until the training is ended.

During the training, the objective function and the loss function are determined by a transient state control objective. Because acceleration control is to make the speed reach the target speed in the minimum time on the premise of satisfying various performance and safety indexes, the objective function can be set as:

$$J = {\sum }_{k = 1}^{m} {( 1 - \frac{{n}_{H} ( k )}{{n}_{H , MAX}} )}^{2} Δ t$$

In the formula, J is the objective function; k is a current iteration step; m is a maximum iteration step; n_{H} is the high pressure rotor speed; a subscript MAX is a maximum limit; and Δt is a time interval of an iteration step.

Constraints considered in an acceleration process are:

Non-overspeed of a high pressure rotor:

n_{H}≤n_{H,max}

Non-overspeed of a low pressure rotor:

n_{L}≤n_{L,max}

Non-overtemperature of temperature before turbine

T₄≤T_{4,max}

Non-fuel-rich extinction of combustion chamber:

far≤farₘₐₓ

Non-surge of high-pressure compressor:

SM_{c}≤SM_{c,min}

Fuel supply range of combustion chamber:

W_{f,idle}≤W_{f}≤W_{f,max}

Limit on maximum change rate of fuel quantity:

ΔW_{f}≤ΔW_{f,max}

In the above limiting conditions, n_{H} is the high pressure rotor speed; n_{L} is the low pressure rotor speed; T₄ is the total temperature before turbine; far is the fuel-air ratio; SM_{c} is the surge margin of the high-pressure compressor; W_{f} is the fuel flow; ΔW_{f} is the change rate of the fuel flow; a subscript max is a maximum limiting condition; min is a minimum limiting condition; and idle is the idling state of the engine.

When the loss function is set, an excess part can be directly taken as a penalty value to avoid exceeding a constraint boundary. For example, after judging that the overspeed loss of the high pressure rotor has exceeded the boundary, it is set as 0.1*(n_{H}−n_{H,max}). Because the penalty value accumulates over time, it is multiplied by a coefficient less than 1 so that the penalty term may not accumulate so much that it accumulates to negative infinity. Similarly, other limit boundaries can be set in a similar way.

In the process of training, due to the strong nonlinearity of the engine, direct training consumes too much time, and the effect is not very good. Thus, the way of hierarchical training is adopted. Namely, a target value within a general range and a relatively relaxed penalty function are given firstly. After training results satisfy basic requirements, a pre-training model of a previous level is changed to a more strict training parameter for conducting training of the next level until the corresponding requirements are satisfied.

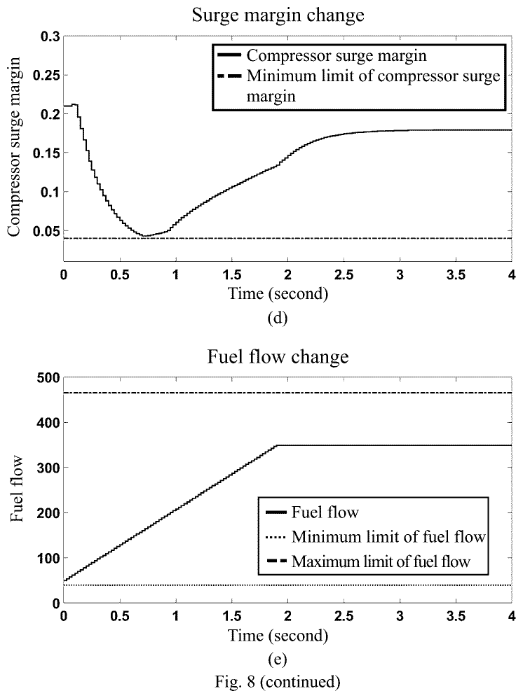

FIG. 8 shows a condition that idle speed is accelerated to 80% speed. This condition simulates the acceleration of the aircraft to its rated flight speed. Fig. (a) is a change curve of the low pressure rotor speed. It can be seen that the aircraft takes 2-4 seconds to accelerate to the target speed, and acceleration time is short. Fig. (b) is a change curve of the high pressure rotor speed, Fig. (c) is a change curve of total temperature before turbine, and Fig. (d) is a change curve of compressor surge margin. It can be seen from the figures that due to the constraints, the total temperature before turbine and the surge margin are within the allowable ranges. Fig. (e) shows a fuel flow required for acceleration, which is also a control quantity. It can be seen from the figure that on the premise of conforming to the corresponding constraints, the greater the upward trend of fuel flow, the better. This also conforms to the desired controller characteristics in the design process.

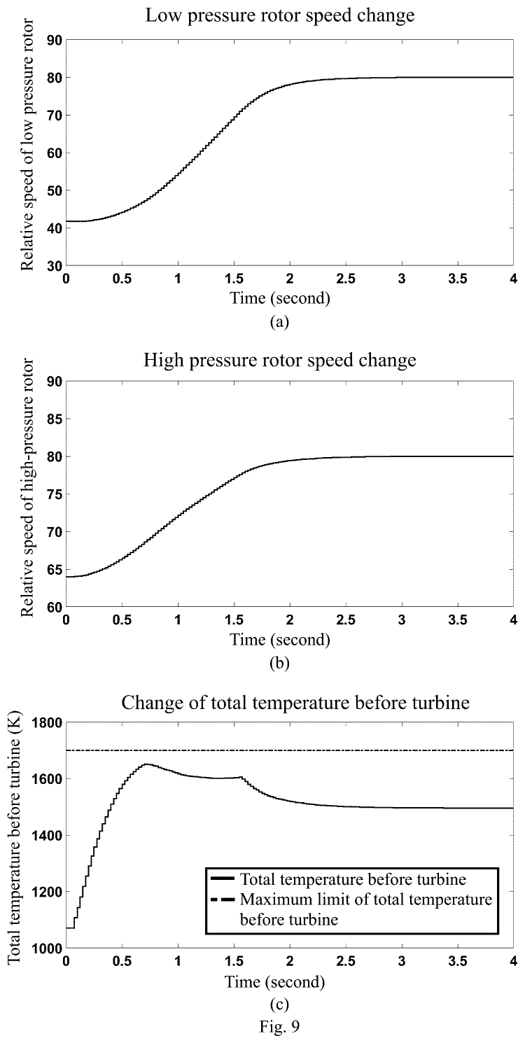

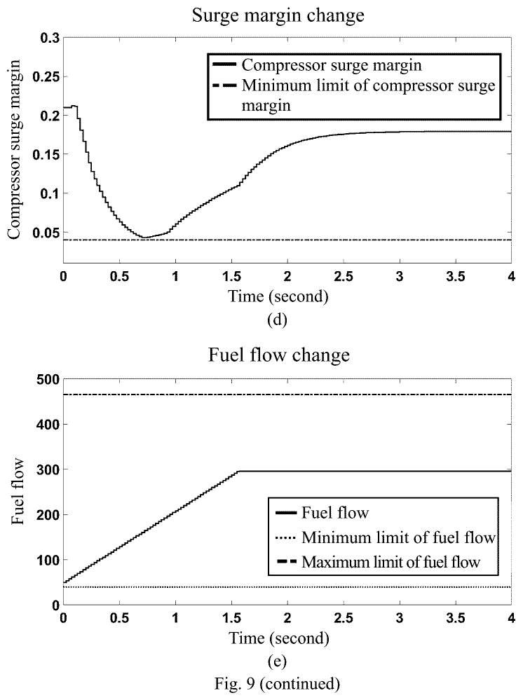

FIG. 9 shows a condition that idle speed is accelerated to 100% speed. This condition simulates the take-off acceleration state of the aircraft, which is more strict to various boundary conditions and requires better engine performance. The meanings of Fig. (a), Fig. (b), Fig. (c), Fig. (d) and Fig. (e) are the same as those described in the above figures. According to the engine principle, the acceleration time should not be infinitely small in the acceleration process, because the acceleration in the shortest time may increase the temperature of the turbine and exceed the boundary, thereby causing damage to the turbine and affecting flight safety. Therefore, it can be seen from Fig. (a) that the acceleration time is 3-5 seconds, which makes various indexes of the engine near but not beyond the boundary. It can be seen from the above process that the controller of the aero-engine transient state based on reinforcement learning can control the engine under various conditions, to conduct acceleration control on the engine under the constraints. The reliability, adaptivity and robustness of the controller are improved due to the advantage of reinforcement learning.

1. An optimization control method for an aero-engine transient state based on reinforcement learning, comprising the following steps:
S1 adjusting a twin-spool turbo-fan engine model as a model for invoking a reinforcement learning algorithm;
S2 to simultaneously satisfy high level state space and continuous action output of a real-time model, designing an Actor-Critic network model; specifically:
S2.1 generating actions by an Actor network which is composed of a traditional deep neural network, wherein the output behavior aₜ of each step can be determined by a deterministic policy function β(sₜ) and an input state s; fitting the policy function by the deep neural network, with a parameter of θ^{μ};
S2.2 designing a corresponding Actor network structure, comprising an input layer, a hidden layer and an output layer, wherein the hidden layer maps a state to a feature, normalizes the output of a previous layer and simultaneously inputs an action value;
S2.3 the Critic network is used for evaluating the performing quality of the action, and is composed of the deep neural network; an input thereof is a state-action group (s, a), an output is a Q value function of a state-action value function and a parameter is θ^{Q};
S2.4 designing a Critic network structure, and adding the hidden layer after the input state s; meanwhile, because the input of the Critic network should have an action a, feature extraction is carried out after weighted summation with the features of the state s; a final output result is a Q value related to the performing quality of the action;
S2.5 using the deep neural network as a function fitter;
S3 designing a deep deterministic policy gradient (DDPG) algorithm based on an Actor-Critic frame, estimating the Q value by the Critic network, outputting an action by the Actor network, and simultaneously solving the problems of high-dimensional state space and continuous action output which cannot be solved by the traditional DQN algorithm; specifically:
S3.1 reducing the correlation between samples by an experience replay method and a batch normalization method, wherein a target network adopts a soft update mode to make the weight parameters of the network approach an original training network slowly to ensure the stability of network training; and deterministic behavior policies make the output of each step computable;
S3.2 the core problem of the DDPG algorithm is to process a training objective, that is, to maximize a future expected reward function J(μ), while minimizing a loss function L(θ^{Q}) of the Critic network; therefore, an appropriate reward function should be set to make the network select an optimal policy; the optimal policy μ is defined as a policy that maximizes J(μ), which is defined as μ=argmax_{μ}J(μ); according to the target requirements of the transient state, the objective function is defined as minimizing surge margin, total temperature before turbine and acceleration time;
S3.3 the DDPG algorithm is an off-policy algorithm, and the process of learning and exploration in continuous space can be independent of the learning algorithm; therefore, it is necessary to add noise to the output of the Actor network policy to serve as a new exploration policy;
S3.4 standardizing each dimension of a training sample to have unit mean value and variance;
S4 training the model after combining the Actor-Critic frame with the DDPG algorithm; specifically:
S4.1 firstly, building corresponding modules for calculating reward and penalty functions according to the existing requirements;
S4.2 combining the engine model with a reinforcement learning network to conduct batch training; during training, increasing the range of a target reward value for pre-training; and after basic requirements are satisfied, reducing the range of the target reward value successively until the corresponding requirements are satisfied;
S4.3 to make the policy optimal and a controller robust, adding±5% random quantity to a reference target to make a current controller model have optimal control quantity output;
S4.4 to design a fuel supply law which satisfies multiple operating conditions, changing the target speed of a rotor on the premise of keeping height and Mach number unchanged, and conducting the training for several times;
S5 obtaining the control law of engine acceleration transition from the above training process, and using the method to control the engine acceleration process, which mainly comprises the following steps:
S5.1 after the training, obtaining corresponding controller parameters, wherein each operating condition corresponds to a controller parameter and at this time, the controller input is a target speed value and the output is a fuel flow supplied to the engine;
S5.2 directly giving the control law by the model under the current operating condition, and controlling the transient state of the engine acceleration process by directly communicating the output of the model with the input of the engine.

2. The optimization control method for the aero-engine transient state based on reinforcement learning according to claim 1, wherein the step S1 specifically comprises:
S1.1 selecting input and output variables of the twin-spool turbo-fan engine model according to the control requirements for the engine transient state, comprising fuel flow, flight conditions, high and low pressure rotor speed, fuel-air ratio, surge margin and total turbine inlet temperature;
S1.2 packaging the adjusted twin-spool turbo-fan engine model as a directly invoked real-time model.

3. The optimization control method for the aero-engine transient state based on reinforcement learning according to claim 1, wherein in the Actor network structure of step S2.2, the activation function used can select ReLU function or Tanh function.
